(19) United States
(12) Patent Application Publication
(10) Pub. No.: US 2015/0136879 A1
(43) Pub. Date: May 21, 2015

(54) FUEL INJECTOR

(71) Applicant: Robert Bosch GmbH, Stuttgart (DE)

(72) Inventors: Jochen Rager, Bisingen (DE); Andreas Buergel, Ottensheim (AT); Joachim Fleuren, Urbach (DE); Bernd Reinsch, Ludwigsburg (DE); Johannes Schmid, Immenstadt (DE); Dieter Maier, Rettenberg (DE); Helmut Sattmann, Frohom (AT); David Holzer, Linz (AT); Andreas Stimmeder, Linz (AT); Dieter Deutsch, St. Florian (AT)

(21) Appl. No.: 14/405,722

(22) PCT Filed: Apr. 5, 2013
(86) PCT No.: PCT/EP2013/057249

§ 371 Date: Dec. 4, 2014

(30) Foreign Application Priority Data
May 31, 2012 (DE) 10 2012 209 229.3

(51) Int. Cl. F02M 51/06

(52) U.S. Cl. CPC F02M 51/0614
USPC 239/585.5

(57) ABSTRACT

The invention relates to a fuel injector having an electromagnet 2 which contains a magnet core 6 and a coil 7 and which further has an armature 9 that is guided on an armature pin 8. The armature pin 8 is guided in a guide sleeve 11 which projects into the electromagnet 2. The fuel injector further has an injector body 4 with at least one injection opening which is introduced into the injector body 4 and which is controlled by an injector needle 5. The aim of the invention is to provide a fuel injector which is functionally improved with respect to the switching times of the fuel injector and the forces that can be generated in the fuel injector while simultaneously simplifying a guide sleeve for an armature pin. This is achieved in that the guide sleeve 11 is integrated into the magnet core 6 and is connected to the magnet core 6 in a formfitting or bonded manner. For this purpose, the guide sleeve 11 has widened sections 16 at both ends, said widened sections fixing the guide sleeve 11 in the magnet core 6.

### BACKGROUND OF THE INVENTION

The present invention relates to a fuel injector having an electromagnet, which contains a magnet core and a coil and which further has an armature that is guided on an armature pin, wherein the armature pin is guided in a guide sleeve, which projects into the electromagnet, further having an injector body with at least one injection opening, which is introduced into the injector body and which is controlled by an injector needle.

A fuel injector of this kind is known from DE 10 2008 040 589 A1. This fuel injector has a guide sleeve which extends into a magnet core of an electromagnet and is inserted into the magnet core, forming an annular gap in the process, and welded to said core. An armature pin connected to an armature is guided in the guide sleeve. A hydraulic damping space, which interacts with the armature or the armature pin, is recessed into the guide sleeve in a region adjacent to the armature. By means of this hydraulic, fuel-filled damping space, the movement of the armature assembly is damped, thereby at least reducing a rebound, in particular, of a valve member actuated by the electromagnet.

Another fuel injector having a guide sleeve for an armature pin is known from DE 35 16 337 A1. This guide sleeve is produced from a non-magnetizable material.

### SUMMARY OF THE INVENTION

It is the underlying object of the invention to provide a fuel injector which is improved as regards its operation in respect of the operating times of the fuel injector and the forces that can be produced while at the same time simplifying a guide sleeve for an armature pin.

This object is achieved by virtue of the fact that the guide sleeve is integrated into the magnet core and is connected positively or materially to the magnet core. In this case, the positive or material connection, which is in the form of a riveted joint for example, is essential to the invention. This configuration simplifies the manufacturing process for the magnet sleeve, in particular, since the guide sleeve is integrated directly into the magnet core and the magnet sleeve no longer has a guiding function and hence no longer has different hardness requirements.

As a development of the invention, the guide sleeve is inserted into the magnet core without an annular gap. By means of this configuration, the inner pole surface of the magnet core can be enlarged through the omission of the encircling gap. This improves the effectiveness of the electromagnet in respect of the operating times thereof and the forces that can be produced.

As a development of the invention, the guide sleeve has widened end portions. These widened end portions form the positive connection to the magnet core. In this case, said widened portions can be worked into the guide sleeve in the manner of a riveted joint, for example, after the insertion of the guide sleeve into the magnet core, wherein corresponding openings to accommodate material can be recessed into the magnet core during the production thereof.

Depending on the material used for the guide sleeve, however, it is also possible for the widened portions to be worked into the guide sleeve during the production thereof, in which case the magnet core is injection-molded around the guide sleeve, preferably from a metallic material. This injection molding of metal is known by the term MIM (metal injection molding). In this process, a metal powder mixed with a binder is injection-molded around the guide sleeve and the composite produced in this way is then sintered in a furnace. Here, the guide sleeve can be in the green condition or in a pre-sintered condition or in a fully sintered condition.

In another embodiment of the invention, the magnet core, which is preferably of soft magnetic design, has at least one radial slot. This avoids eddy currents in the guide region and thus also improves the functionality of the fuel injector.

As a development of the invention, the material of the guide sleeve is a material that is not magnetic and is not electrically conductive. Stray flux via the armature pin is thereby avoided. Stray flux is avoided if the material is not magnetic, but it does not necessarily have to be electrically nonconductive to achieve this. The radial slot or slots in the magnet core can be filled with the material of the guide sleeve. This embodiment can be implemented, in particular, if the magnet core is injection-molded around the guide sleeve. Moreover, this embodiment allows a simplified guide sleeve which, in particular, is inserted without a radial gap into the magnet core to enhance the functionality of the electromagnet, wherein the magnet core is injection-molded without an annular gap around the guide sleeve. By dispensing with the annular gap, it is possible to enlarge the pole surface of the magnet core, for example.

As a development of the invention, the guide sleeve is produced from a material that is not magnetic and is electrically conductive. In this embodiment too, stray flux is suppressed. Like the abovementioned embodiment, this embodiment allows a simplified guide sleeve which, in particular, is inserted without a radial gap into the magnet core to enhance the functionality of the electromagnet.

In another embodiment, provision is made for the material of the guide sleeve to be magnetically and electrically conductive. In this case, insulation relative to the magnet core is required, wherein said insulation can be produced or ensured by an insulating interlayer or an annular gap between the guide sleeve and the magnet core. This embodiment also makes possible a simplified guide sleeve.

In a development of the invention, the material of the guide sleeve is a ceramic material. A ceramic material has a high hardness and therefore a particular suitability for the production of a guide sleeve. Since a ceramic material is difficult to machine subsequently, the magnet core is injection-molded around the guide sleeve produced from ceramic, for example. There are several possibilities for the corresponding production process: 1) A green component (injection molding in the form of the magnet core) is sintered onto a ready-sintered ceramic part in the form of the guide sleeve. 2) A green component (injection molding in the form of the magnet core) is sintered onto a pre-sintered ceramic part in the form of the guide sleeve. 3) Two injection-molded green components (injection molding in the form of the magnet core and a ceramic part in the form of the guide sleeve) are sintered either simultaneously or sequentially. The component parts of the fuel injector which are produced in this way are then assembled with the other component parts, e.g. the coil, the armature pin, the armature and the injector body with the injector needle. In this case, the fuel injector constructed in this way is simplified as compared with a conventionally designed fuel injector having a guide sleeve welded to the magnet core.

In another embodiment of the invention, the material of the guide sleeve is an austenitic steel. An austenitic steel is likewise highly suitable and also reduces stray flux since it is also not magnetic.

### BRIEF DESCRIPTION OF THE DRAWINGS

Advantageous embodiments of the invention can be found in the description of the drawings, in which an illustrative embodiment of the invention shown in the figures is described in greater detail.

In the drawings:

FIG. 1 shows a section through the region of a fuel injector of relevance to the invention,

FIG. 2 shows a detail enlargement from FIG. 1,

FIG. 3 shows a detail view according to FIG. 2, and

FIG. 4 shows a perspective view of a magnet core injection-molded around a guide sleeve.

### DETAILED DESCRIPTION

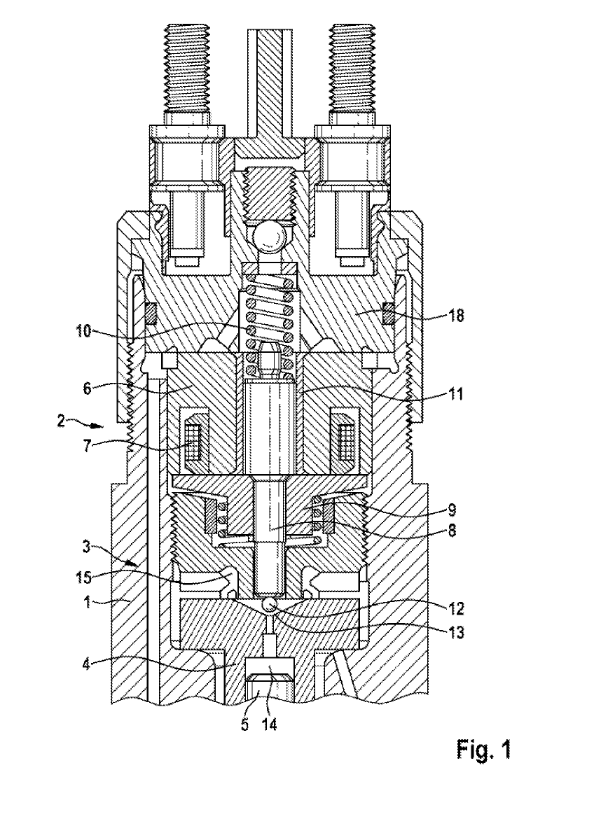

FIG. 1 shows a section through a region of a fuel injector of relevance to the invention, said fuel injector being designed for the injection of fuel, in particular diesel fuel, into a combustion chamber of an internal combustion engine, in particular a self-ignition internal combustion engine. The associated injection system is preferably designed as a common rail injection system and has a fuel feed system, consisting inter alia of a low pressure pump and of a high pressure pump, by which fuel is pumped from a tank into a high pressure reservoir. The high pressure reservoir is connected to the fuel injector, which takes fuel for injection into the combustion chamber from the high pressure reservoir when required.

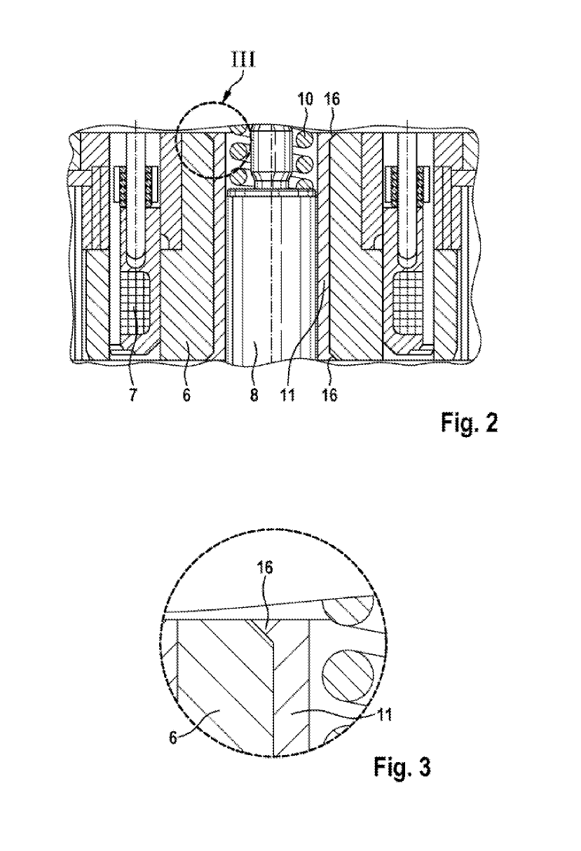

The fuel injector has an injector housing 1, into which an actuator in the form of an electromagnet 2, a valve 3 actuated by the electromagnet 2, and an injector body 4 with an injector needle 5 are installed. The electromagnet 2 has a single-part or multi-part magnet core 6, in which at least one coil 7 is arranged. If the coil 7 is energized, a magnetic field is built up, and an armature 9 guided on an armature pin 8 is moved toward the magnet core 6 against the force of a compression spring 10. The compression spring 10 is arranged in a magnet sleeve 18 composed of hardened or unhardened steel (the latter especially if the guide sleeve does not have to guide). The armature pin 8 is guided in a guide sleeve 11. The guide sleeve 11 and the interaction thereof with the magnet core 6 is explained in greater detail below in the detail enlargement of FIG. 2.

The armature pin 8 interacts with the valve 3, which essentially has a valve ball 12 seated on a valve seat 13. If the electromagnet 2 is not energized, the valve ball 12 rests in the valve seat 13, and a flow connection between a control space 14 arranged in the injector body 4 adjacent to one end of the injector needle 5 and a discharge space 15 is interrupted. The discharge space 15 is connected via a discharge line to the low pressure system or the tank of the injection system, while the control space 14 is connected via a feed passage (not shown) containing a feed restrictor to the high pressure reservoir of the injection system. In this operating state, high pressure prevails in the control space, and the injector needle closes injection openings (not shown) in the injector body 4, through which, in the open state, fuel is injected into the associated combustion chamber of an internal combustion engine.

If the electromagnet 2 is energized, the armature pin 8 is moved away from the valve ball 12 by means of the armature 9 and thus allows the opening of the flow connection controlled by the valve ball 12 and the valve seat 13 from the control space 14 into the discharge space 15. As a result, the fuel pressure in the control space 14 falls, and the injector needle 5 is moved in the direction of the control space 14. As a result, the injection openings in the injector body 4 at the opposite end of the injector needle 5 are exposed, and the highly pressurized fuel supplied from the high pressure reservoir flows through said openings and is injected into the associated combustion chamber.

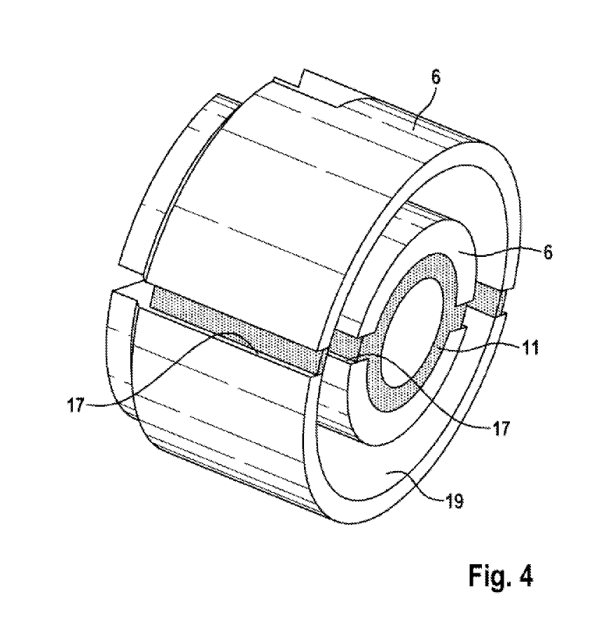

The detail enlargement of the fuel injector, which is shown in FIG. 2, shows the region of the magnet core 6 with the guide sleeve 11, the latter being arranged in the magnet core 6 and being connected positively thereto. At its two opposite ends, the guide sleeve 11 has widened portions 16 (see also the detail enlargement of FIG. 3), by means of which the guide sleeve 11 is held positively in the magnet core 6. At one end of the guide sleeve 11, the widened portion 16 can be worked into the guide sleeve 11 before insertion of the guide sleeve 11 into the magnet core 6, and the opposite widened portion 16 is then made after the insertion of the guide sleeve 11 into the magnet core 6, if the material of the guide sleeve 11 is produced from a deformable material, e.g. from an austenitic steel. Of course, it is also possible for both widened portions 16 to be worked into the guide sleeve 11 after insertion into the magnet core 6.

If, on the other hand, the material of the guide sleeve is a non-deformable material, e.g. ceramic, the opposite widened portions must be made or produced during the production of the guide sleeve 11. In this case, the magnet core 6 is injection-molded around the guide sleeve 11 and, after the injection-molding process, the components pre-produced in this way are then sintered in a furnace. A method of this kind is known by the term MIM (metal injection molding).

FIG. 4 shows, in a perspective view, a magnet core 6, which is injection-molded around a guide sleeve 11 composed, for example, of a ceramic material. The magnet core 6 has radial slots 17, which are filled with the material of the guide sleeve 11, or the magnet core 6 is injection-molded around the guide sleeve 11 correspondingly produced with projections. Appropriate material allowances are allowed for and added in the production of the guide sleeve 11 from ceramic. An opening 19 to receive the coil 7 is furthermore recessed into the magnet core 6.

1. A fuel injector having an electromagnet (2), which contains a magnet core (6) and a coil (7) and which further has an armature (9) that is guided on an armature pin (8), wherein the armature pin (8) is guided in a guide sleeve (11), which projects into the electromagnet (2), further having an injector body (4) with at least one injection opening, which is introduced into the injector body (4) and which is controlled by an injector needle (5), characterized in that the guide sleeve (11) is integrated into the magnet core (6) and is connected positively to the magnet core (6).

2. The fuel injector as claimed in claim 1, characterized in that the guide sleeve (11) has widened end portions (16).

3. The fuel injector as claimed in claim 1, characterized in that the guide sleeve (11) is inserted into the magnet core (6) without an annular gap.

4. The fuel injector as claimed in claim 1, characterized in that the magnet core (6) has at least one radial slot 17.

5. The fuel injector as claimed in claim 1, characterized in that the guide sleeve is made of a material that is not magnetic and is not electrically conductive.

6. The fuel injector as claimed in claim 1, characterized in that the guide sleeve is made of a material that is not magnetic and is electrically conductive.

7. The fuel injector as claimed in one of claims 1 to claim 1, characterized in that the guide sleeve is made of a material that is magnetic and electrically conductive.

8. The fuel injector as claimed in claim 1, characterized in that the guide sleeve is made of a material that is magnetic and is not electrically conductive.

9. The fuel injector as claimed in claim 1, characterized in that the guide sleeve (11) is made of a ceramic material.

10. The fuel injector as claimed in claim 1, characterized in that the guide sleeve (11) is made of austenitic steel.

11. The fuel injector as claimed in claim 1, characterized in that the magnet core (6) is injection-molded around the guide sleeve (11).

12. The fuel injector as claimed in claim 1, characterized in that an injection molding in the form of the magnet core (6) is sintered onto a ready-sintered ceramic part in the form of the guide sleeve (11).

13. The fuel injector as claimed in claim 1, characterized in that an injection molding in the form of the magnet core (6) is sintered onto a pre-sintered ceramic part in the form of the guide sleeve (11).

14. The fuel injector as claimed in claim 1, characterized in that two injection moldings in the form of the magnet core (6) and of a ceramic part in the form of the guide sleeve (11) are sintered sequentially.

15. The fuel injector as claimed in claim 1, characterized in that the guide sleeve is made of ferrite.

16. The fuel injector as claimed in claim 1, characterized in that two injection moldings in the form of the magnet core (6) and of a ceramic part in the form of the guide sleeve (11) are sintered simultaneously.
